(19) United States
(12) Patent Application Publication
(10) Pub. No.: US 2026/0194354 A1
(43) Pub. Date: Jul. 9, 2026

(54) Processing Method and Device for Sensor Data, and Computer-Readable Storage Medium

(71) Applicant: EHANG INTELLIGENT EQUIPMENT (GUANGZHOU) CO., LTD., Guangzhou, Guangdong (CN)

(72) Inventors: Huazhi Hu, Guangzhou, Guangdong (CN); Yong Liu, Guangzhou, Guangdong (CN); Junhao Yao, Guangzhou, Guangdong (CN); Huipeng Xie, Guangzhou, Guangdong (CN)

(21) Appl. No.: 19/130,574

(22) PCT Filed: Nov. 14, 2023
(86) PCT No.: PCT/CN2023/131500

§ 371 Date: May 16, 2025

(30) Foreign Application Priority Data
Nov. 17, 2022 (CN) 202211439032.2

(51) Int. Cl. G01C 21/16; G01C 21/20

(52) U.S. Cl. CPC G01C 21/16; G01C 21/20

(57) ABSTRACT

A processing method and device for sensor data, and a computer-readable storage medium is disclosed, wherein the processing method includes: performing preset comparison, shaping, and filtering process on a first sensor data acquired by a plurality of sensors of an aircraft according to categories of the sensors respectively, to obtain a second sensor data; performing alignment process on the second sensor data by means of a preset data buffer and motion states represented by each of the sensors, to obtain a third sensor data; performing data fusion process on the third sensor data in a loose coupling manner, and performing calculation to obtain a current required motion information.

### TECHNICAL FIELD

This application relates to a technical field of unmanned aerial aircrafts, and in particular, to a processing method and device for sensor data, and a computer-readable storage medium.

### BACKGROUND ART

In the existing unmanned aerial aircraft technology, a navigation system first obtains a raw motion data of the aircraft from each sensor module, which includes an angular rate or acceleration information of IMU (Inertial Measurement Unit), a velocity or position information of GNSS (Global Navigation Satellite System), an atmospheric information of BARO (Barometer), a geomagnetic information of MAG (Magnetometer) and other raw observation data; then, the navigation system performs single-sensor observation for each of the above sensors to obtain a motion information characterized by each sensor. However, the motion information obtained by the single-sensor observation scheme generally suffers from poor accuracy, low bandwidth, and poor robustness.

When the navigation system calculates the raw observation data into the motion information required for guidance and control, how to process and fuse the raw observation data from each of the sensors to improve an accuracy and numerical stability of filtering calculations has become a technical problem to be solved.

### SUMMARY OF THE INVENTION

### Technical Issue

This application provides a processing method and device for sensor data, and a computer-readable storage medium, in order to solve the problem of how to improve the accuracy and numerical stability of filtering calculations when processing and fusing the raw observational data from a plurality of sensors.

### Technical Solution

The method includes:

performing preset comparison, shaping, and filtering process on a first sensor data acquired by a plurality of sensors of an aircraft according to categories of the sensors respectively, to obtain a second sensor data;

performing alignment process on the second sensor data by means of a preset data buffer and motion states represented by each of the sensors, to obtain a third sensor data; and

performing data fusion process on the third sensor data in a loose coupling manner, and performing calculation to obtain a current required motion information, wherein an observation model of the data fusion is decoupled into independent measurement equations corresponding to each sensor, and measurement values of each sensor obtained from the measurement equations are sequentially fused during measurement updates.

This application also provides a processing device for sensor data, the device including a memory, a processor and a computer program stored on the memory and executable on the processor, wherein the computer program, when executed by the processor, implements steps of the above processing method for sensor data.

This application also provides a computer-readable storage medium, storing a processing program for sensor data, wherein the processing program, when executed by a processor, implements steps of the above processing method for sensor data.

### Beneficial Effect

The processing method and device for sensor data, and the computer-readable storage medium of this application, performs preset comparison, shaping, and filtering process on the first sensor data acquired by a plurality of sensors of the aircraft according to categories of the sensors respectively, to obtain the second sensor data; performs alignment process on the second sensor data by means of the preset data buffer and motion states represented by each of the sensors, to obtain the third sensor data; performs data fusion process on the third sensor data in the loose coupling manner, and performs calculation to obtain the current required motion information, wherein the observation model of the data fusion is decoupled into independent measurement equations corresponding to each sensor, and measurement values of each sensor obtained from the measurement equations are sequentially fused during measurement updates. Thereby, a multi-sensor data processing and fusion scheme is realized, which enables the aircraft to obtain the motion information with higher accuracy and bandwidth, and better stability and robustness.

### DESCRIPTION OF THE DRAWINGS

This application is further described below in connection with drawings and embodiments. In the drawings:

FIG. 1 is a flowchart of a first embodiment of a processing method for sensor data of the present disclosure;

FIG. 2 is a first flowchart of a second embodiment of the processing method for sensor data of the present disclosure;

FIG. 3 is a second flowchart of the second embodiment of the processing method for sensor data of the present disclosure;

FIG. 4 is a third flowchart of the second embodiment of the processing method for sensor data of the present disclosure;

FIG. 5 is a fourth flowchart of the second embodiment of the processing method for sensor data of the present disclosure;

FIG. 6 is a fifth flowchart of the second embodiment of the processing method for sensor data of the present disclosure;

FIG. 7 is a flowchart of a third embodiment of the processing method for sensor data of the present disclosure;

FIG. 8 is a flowchart of a fourth embodiment of the processing method for sensor data of the present disclosure;

FIG. 9 is a first flow chart of a fifth embodiment of a method of processing sensor data of the present invention;

FIG. 10 is a second flowchart of the fifth embodiment of a method of processing sensor data of the present invention;

FIG. 11 is a third flowchart of the fifth embodiment of a method of processing sensor data of the present invention;

FIG. 12 is a schematic diagram of acquisition control logic for a first-category sensor data of the second embodiment of the processing method for sensor data of the present disclosure;

FIG. 13 is a schematic diagram of acquisition control logic for a second-category sensor data of the second embodiment of the processing method for sensor data of the present disclosure;

FIG. 14 is a schematic diagram of a sensor data cache structure of the third embodiment of the processing method for sensor data of the present disclosure;

FIG. 15 is a block diagram of data processing of a fourth embodiment of the processing method for sensor data of the present disclosure.

### DETAILED DESCRIPTION OF INVENTION

It should be understood that the specific embodiments described herein are merely for explaining the application and are not intended to limit the application.

### Embodiment 1

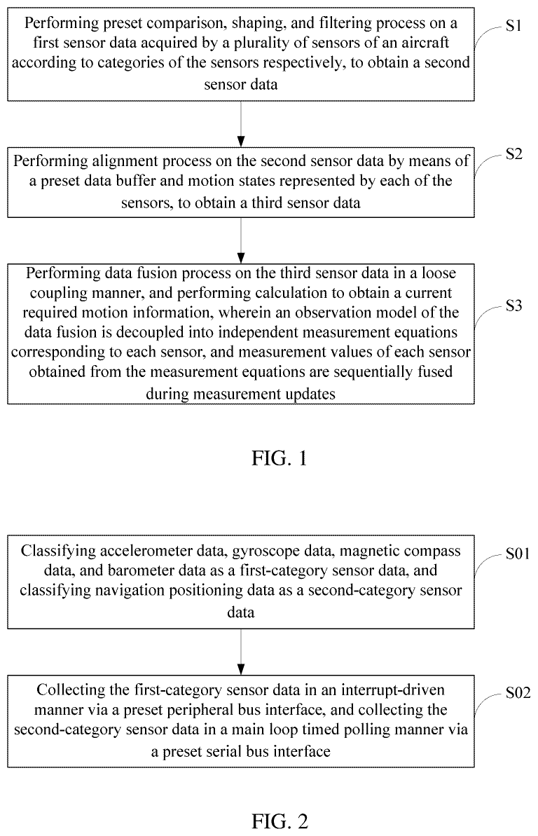

FIG. 1 is a flowchart of a first embodiment of a processing method for sensor data of the present disclosure. The method includes:

S1, performing preset comparison, shaping, and filtering process on a first sensor data acquired by a plurality of sensors of an aircraft according to categories of the sensors respectively, to obtain a second sensor data.

S2, performing alignment process on the second sensor data by means of a preset data buffer and motion states represented by each of the sensors, to obtain a third sensor data.

S3, performing data fusion process on the third sensor data in a loose coupling manner, and performing calculation to obtain a current required motion information, wherein an observation model of the data fusion is decoupled into independent measurement equations corresponding to each sensor, and measurement values of each sensor obtained from the measurement equations are sequentially fused during measurement updates.

In this embodiment, first, performing preset comparison, shaping, and filtering process on the first sensor data acquired by a plurality of sensors of the aircraft according to categories of the sensors respectively, to obtain the second sensor data. Wherein the first sensor data is the raw motion data of the aircraft acquired by the navigation system of the aircraft from each sensor module, the first sensor data includes the angular rate or acceleration information of the IMU (Inertial Measurement Unit), the velocity or position information of the GNSS (Global Navigation Satellite System), the atmospheric information of the BARO (Barometer), the geomagnetic information of the MAG (Magnetometer), and other raw observation data. In this embodiment, after acquiring the first sensor data, the first sensor data is used as an observation input, and a preprocessing operation of filter correction and wild value rejection is performed, thereby completing preliminary shaping and screening of the first sensor data, and obtaining the second sensor data of this embodiment.

In this embodiment, after obtaining the second sensor data of this embodiment, performing alignment process on the second sensor data by means of the preset data buffer and motion states represented by each of the sensors, to obtain the third sensor data. Wherein considering that a sampling rate of the raw observation data of each sensor spans a large range, and there are also differences in a degree of observation lag between each sensor, this embodiment performs data synchronization on the second sensor data before fusing the second sensor data, so as to complete the alignment process on the sensor samples in a time sequence, and obtain the third sensor data of this embodiment.

In this embodiment, after obtaining the third sensor data of this embodiment, performing data fusion process on the third sensor data in the loose coupling manner, and performing calculation to obtain the current required motion information, wherein the observation model of the data fusion is decoupled into independent measurement equations corresponding to each sensor, and measurement values of each sensor obtained from the measurement equations are sequentially fused during measurement updates. In this embodiment, for the pre-processed third sensor data, an optimal estimation technique based on EKF (Extended KalmanFilter) is used to perform the fusion operation of the multi-sensor data, such as IMU, GPS, BARO, and MAG, as well as to calculate the motion information, such as attitude, velocity, and position, required for the control of the aircraft.

It can be seen that in this embodiment, more accurate, higher bandwidth, and more robust motion information can be obtained using multi-sensor data fusion techniques compared to existing single-sensor observation schemes.

This embodiment performs preset comparison, shaping, and filtering process on the first sensor data acquired by a plurality of sensors of the aircraft according to categories of the sensors respectively, to obtain the second sensor data; performs alignment process on the second sensor data by means of the preset data buffer and motion states represented by each of the sensors, to obtain the third sensor data; performs data fusion process on the third sensor data in the loose coupling manner, and performs calculation to obtain the current required motion information, wherein the observation model of the data fusion is decoupled into independent measurement equations corresponding to each sensor, and measurement values of each sensor obtained from the measurement equations are sequentially fused during measurement updates. This embodiment realizes a multi-sensor data processing and fusion scheme, which enables the aircraft to obtain the motion information with higher accuracy and bandwidth, and better stability and robustness.

### Embodiment 2

FIG. 2 is a first flowchart of a second embodiment of the processing method for sensor data of the present disclosure. Based on the above embodiment, performing preset comparison, shaping, and filtering process on the first sensor data acquired by a plurality of sensors of the aircraft according to categories of the sensors respectively, to obtain the second sensor data, includes:

S01, classifying accelerometer data, gyroscope data, magnetic compass data, and barometer data as a first-category sensor data, and classifying navigation positioning data as a second-category sensor data.

S02, collecting the first-category sensor data in an interrupt-driven manner via a preset peripheral bus interface, and collecting the second-category sensor data in a main loop timed polling manner via a preset serial bus interface.

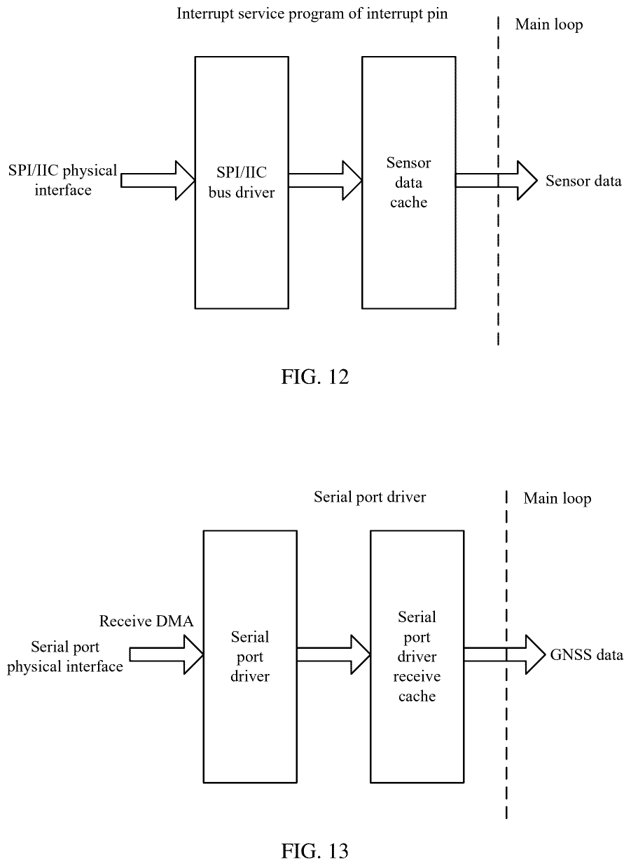

In this embodiment, as shown in FIG. 12, which illustrates acquisition control logic for a first-category sensor data. Wherein, for data generated by the IMU, BARO and MAG, first of all, a corresponding sensor interrupt output pin is used to generate a corresponding pulse jump signal, which controls a interrupt service program of the corresponding interrupt pin; then, the interrupt service program reads data with preset SPI/IIC peripheral bus driver and stores the data into a data cache of each sensor; finally, a preset software main loop reads the data currently stored in the sensor.

In this embodiment, as shown in FIG. 13, which illustrates acquisition control logic for a second-category sensor data. Wherein, for data generated by the GNSS, first of all, the data generated by the GNSS is received by a preset serial port driver via DMA (Direct Memory Access); then, the data generated by the GNSS is stored in a receive cache of the serial port driver; and finally, the preset software main loop reads and parses the data generated by the GNSS at regular intervals.

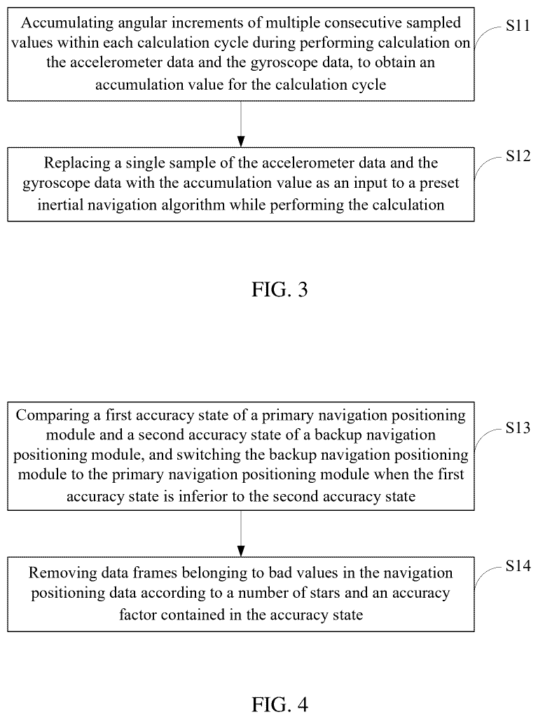

FIG. 3 is a second flowchart of the second embodiment of the processing method for sensor data of the present disclosure. Performing preset comparison, shaping, and filtering process on the first sensor data acquired by a plurality of sensors of the aircraft according to categories of the sensors respectively, to obtain the second sensor data, further includes:

S11, accumulating angular increments of multiple consecutive sampled values within each calculation cycle during performing calculation on the accelerometer data and the gyroscope data, to obtain an accumulation value for the calculation cycle.

S12, replacing a single sample of the accelerometer data and the gyroscope data with the accumulation value as an input to a preset inertial navigation algorithm while performing the calculation.

In this embodiment, a low-pass digital filter is used to perform data shaping on the raw observation data of the gyroscope and accelerometer of the IMU, so as to suppress high-frequency noise signals and to avoid high-frequency interference from entering navigation calculation to affect the accuracy of subsequent EKF calculation.

In this embodiment, considering that the subsequent inertial guidance calculation uses an angular incremental algorithm, this embodiment performs angular incremental conversion processing for the angular rate observation data of the IMU.

In this embodiment, considering that an update rate of the IMU is generally much higher than a frequency of the navigation calculation, this embodiment accumulates angular increments of a plurality of consecutive sampling values within each calculation cycle, and replaces a single IMU sample with the accumulation value as the input to the inertial navigation algorithm to calculate, thereby reducing a consumption of computational resources of the aircraft while guaranteeing the accuracy.

FIG. 4 is a third flowchart of the second embodiment of the processing method for sensor data of the present disclosure. Performing preset comparison, shaping, and filtering process on the first sensor data acquired by a plurality of sensors of the aircraft according to categories of the sensors respectively, to obtain the second sensor data, further includes:

S13, comparing a first accuracy state of a primary navigation positioning module and a second accuracy state of a backup navigation positioning module, and switching the backup navigation positioning module to the primary navigation positioning module when the first accuracy state is inferior to the second accuracy state.

S14, removing data frames belonging to bad values in the navigation positioning data according to a number of stars and an accuracy factor contained in the accuracy state.

In this embodiment, two independent GPS modules are provided within flight control of the aircraft, wherein one is a primary module and the other is a backup module.

In this embodiment, the accuracy state of the two GPS modules is compared in real time, and when it is determined that the accuracy of the primary GPS module is insufficient and inferior to that of the backup GPS module, the primary GPS module is automatically switched to the backup GPS module, so as to input the collected superior navigation positioning data into the subsequent data fusion process.

In this embodiment, before performing data fusion on the navigation positioning data of the GPS, it is determined whether the data frame of the navigation positioning data of the GPS is the bad value based on the number of stars and the accuracy factor of the GPS, and other information. If the data frame is the bad value, it is not used for data fusion.

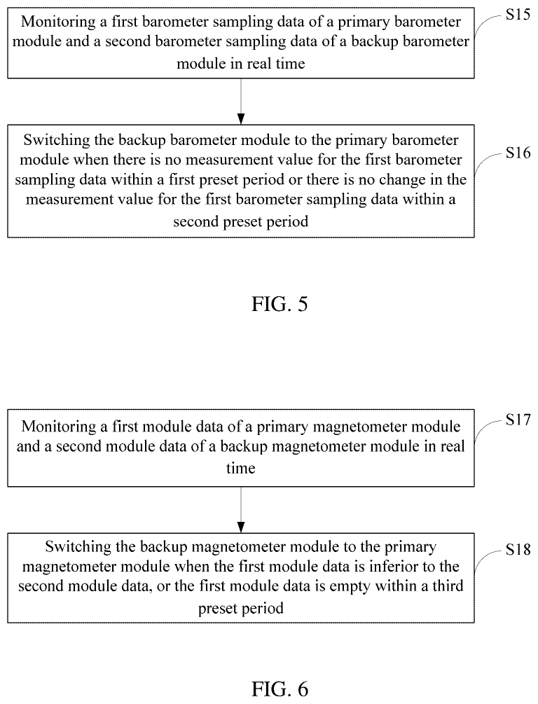

FIG. 5 is a fourth flowchart of the second embodiment of the processing method for sensor data of the present disclosure. Performing preset comparison, shaping, and filtering process on the first sensor data acquired by a plurality of sensors of the aircraft according to categories of the sensors respectively, to obtain the second sensor data, further includes:

S15, monitoring a first barometer sampling data of a primary barometer module and a second barometer sampling data of a backup barometer module in real time.

S16, switching the backup barometer module to the primary barometer module when there is no measurement value for the first barometer sampling data within a first preset period or there is no change in the measurement value for the first barometer sampling data within a second preset period.

In this embodiment, two independent barometer modules are provided within the flight control of the aircraft, wherein one is a primary module that serves as a first barometer and the other is a backup module that serves as a second barometer.

In this embodiment, the two barometer samples are monitored in real time, and when the primary barometer module has no measurements for a long period of time, or the measurements do not change for a long period of time, it is considered that the primary barometer module is unhealthy, and at that time, the primary barometer is automatically switched to the backup barometer, and the observation data from the backup barometer is used for subsequent data fusion.

FIG. 6 is a fifth flowchart of the second embodiment of the processing method for sensor data of the present disclosure. Performing preset comparison, shaping, and filtering process on the first sensor data acquired by a plurality of sensors of the aircraft according to categories of the sensors respectively, to obtain the second sensor data, further includes:

S17, monitoring a first module data of a primary magnetometer module and a second module data of a backup magnetometer module in real time.

S18, switching the backup magnetometer module to the primary magnetometer module when the first module data is inferior to the second module data, or the first module data is empty within a third preset period.

In this embodiment, two independent magnetometer modules are provided within the flight control of the aircraft, wherein one is a primary module and the other is a backup module.

In this embodiment, data quality of the primary module is assessed by filter state estimation, and when the data quality is poor, or no data for an extended period of time, the primary module is switched to the backup module, and the observation data from the backup module are used for subsequent data fusion.

This embodiment effectively avoids possible wild values, bad values, or high-noise observation data from each sensor being input to the subsequent data fusion by pre-processing the raw observation data from each sensor with comparison, data shaping, and data filtering, which improves the accuracy and numerical stability of the EKF.

### Embodiment 3

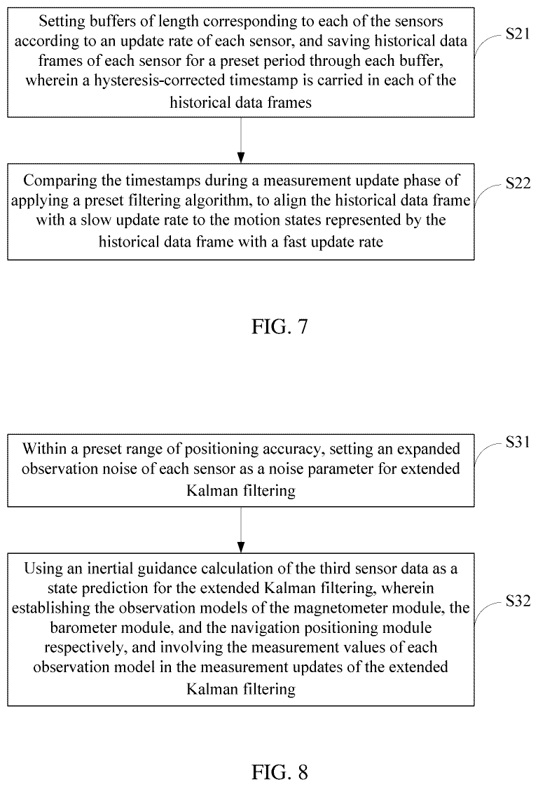

FIG. 7 is a flowchart of a third embodiment of the processing method for sensor data of the present disclosure. Based on the above embodiments, performing alignment process on the second sensor data by means of the preset data buffer and motion states represented by each of the sensors, to obtain the third sensor data, includes:

S21, setting buffers of length corresponding to each of the sensors according to an update rate of each sensor, and saving historical data frames of each sensor for a preset period through each buffer, wherein a hysteresis-corrected timestamp is carried in each of the historical data frames. S22, comparing the timestamps during a measurement update phase of applying a preset filtering algorithm, to align the historical data frame with a slow update rate to the motion states represented by the historical data frame with a fast update rate.

In this embodiment, considering that the sampling rate of each sensor spans a large range, for example, one of the IMU module has a sampling rate of 819.2 Hz and one of the GNSS module has a sampling rate of 5 Hz, and considering that there are also differences in the degree of observation lag between each sensor of different types varies, the motion at a same moment may not be characterized even when compared to the latest samples of each sensor, especially for highly maneuverability flights, such sampling rate and observation lag differences will have a greater impact on the characterization of the motion timing. Therefore, this embodiment designs a corresponding data synchronization mechanism before fusing the above preprocessed data, so as to chronologically align the samples from each sensor.

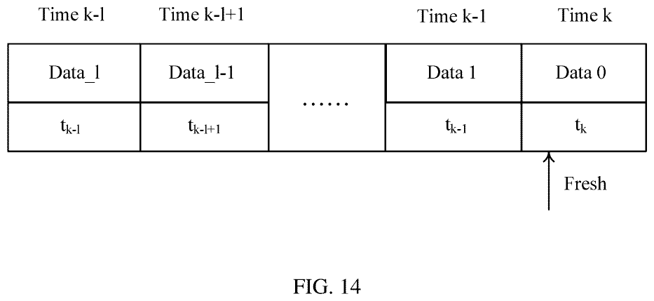

In this embodiment, the above synchronization mechanism is realized by means of a preset data buffer. Therein, refer to the sensor data cache structure illustrated in FIG. 14, considering that the update rate of each sensor is different, this embodiment first sets buffers of different lengths according to different update rates respectively, and saves the historical data frames of corresponding sensors in the most recent period of time through the respective buffers; and then, based on the hysteresis-corrected timestamp carried by each data frame, in the measurement update phase of the filtering algorithm, through the comparison of the above timestamps, so that the motion states characterized by the sensor with a slow update rate and the sensor with a fast update rate are aligned, thereby improving the accuracy of the subsequent calculation and the filtering stability.

### Embodiment 4

FIG. 8 is a flowchart of a fourth embodiment of the processing method for sensor data of the present disclosure. Based on the above embodiments, performing data fusion process on the third sensor data in the loose coupling manner, and performing calculation to obtain the current required motion information, wherein the observation model of the data fusion is decoupled into independent measurement equations corresponding to each sensor, and measurement values of each sensor obtained from the measurement equations are sequentially fused during measurement updates, includes:

S31, within a preset range of positioning accuracy, setting an expanded observation noise of each sensor as a noise parameter for extended Kalman filtering.

S32, using an inertial guidance calculation of the third sensor data as a state prediction for the extended Kalman filtering, wherein establishing the observation models of the magnetometer module, the barometer module, and the navigation positioning module respectively, and involving the measurement values of each observation model in the measurement updates of the extended Kalman filtering.

In this implementation, multi-sensor data fusion for the IMU, GNSS, BARO, and MAG is realized with the EKF.

In this embodiment, with respect to the noise parameter setting of the EKF described above, within the preset range of positioning accuracy, setting the expanded observation noise of each sensor as the noise parameter for the EKF. That is, the sensor observation noise setting is moderately exaggerated without significantly affecting the positioning accuracy, thereby effectively enhancing the robustness of the filtering and calculation process.

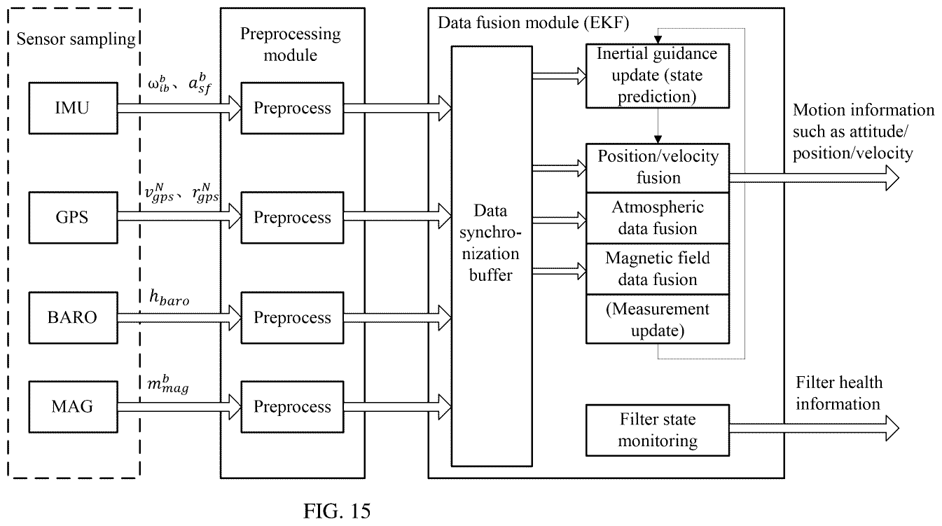

In this embodiment, refer to the data processing block diagram illustrated in FIG. 15, in which the system equations are established with the Jetlink inertial guidance model as the core, and the inertial guidance calculation is used as the state prediction part of the EKF. The system observation model is established for the multi-sensors of the IMU, GNSS, BARO, and MAG, respectively, and the state prediction is performed for the inertial guidance update, and the position or velocity fusion, the atmospheric data fusion, and the magnetic field data fusion are participated as the measurement update to the EKF fusion. In this embodiment, states such as zero bias and temperature drift of the IMU are estimated in real time through multiple iterative calculations, so as to suppress observation noise, as well as to correct cumulative errors of inertial guidance calculation, to obtain high-bandwidth, stable, and accurate motion information.

In this embodiment, multi-sensor data fusion is realized in a loose coupling manner by the above algorithmic model. Wherein, the loose coupling manner is adopted to maintain independence of the GNSS and BARO, that is, when the data quality of a single sensor is detected to be deteriorating, it can be isolated in a timely manner without affecting the normal work of the other independent sensors, so as to enhance a fault-tolerance capability of the navigation system.

In this embodiment, in the implementation of the filtering algorithm, in order to avoid excessive occupation of computational resources, the sequential update algorithm is used for the measurement update part of the filtering. In particular, the observation states of the GNSS, BARO and MAG sensors are kept independent of each other, and the observation model is decoupled into several single-sensor independent measurement equations. It can be seen that this embodiment participates in the measurement update of the EKF in a sequential fusion of the measurements of each sensor, thereby effectively avoiding an inverse operation of higher-order matrices and improving the real-time performance of the filtering calculation.

### Embodiment 5

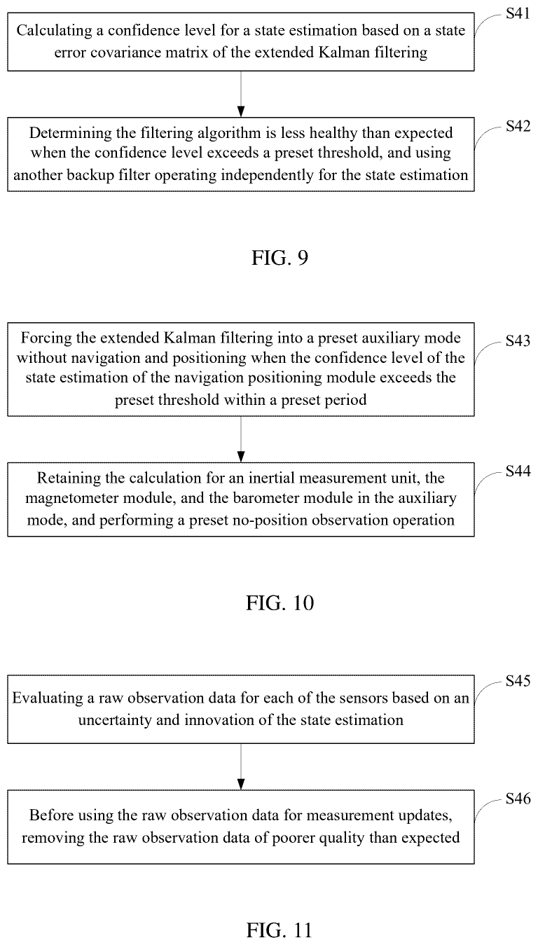

FIG. 9 is a first flow chart of a fifth embodiment of a method of processing sensor data of the present invention. Based on the above embodiments, the method further includes:

S41, calculating a confidence level for a state estimation based on a state error covariance matrix of the extended Kalman filtering.

S42, determining the filtering algorithm is less healthy than expected when the confidence level exceeds a preset threshold, and using another backup filter operating independently for the state estimation.

In this embodiment, first, a confidence level (or uncertainty) of the corresponding state estimation is calculated by the state error covariance matrix of the EKF; and then, based on the confidence level, a healthiness of the filtering algorithm can be assessed. Wherein, a situation in which the uncertainty exceeds a threshold is recognized as the state estimation being unreliable, at which time, switching to another set of backup filters operating independently performs the state estimation.

FIG. 10 is a second flowchart of the fifth embodiment of a method of processing sensor data of the present invention. The method further includes:

S43, forcing the extended Kalman filtering into a preset auxiliary mode without navigation and positioning when the confidence level of the state estimation of the navigation positioning module exceeds the preset threshold within a preset period.

S44, retaining the calculation for an inertial measurement unit, the magnetometer module, and the barometer module in the auxiliary mode, and performing a preset no-position observation operation.

In this embodiment, if the observation data of the GNSS does not pass a confidence test over a long period of time, a timeout mechanism is triggered to force the EKF to enter a NO-GNSS-assisted mode, retaining only the attitude and barometric altitude calculation, and notifying the controller of the need to take a countermeasure with the no-position observation.

FIG. 11 is a third flowchart of the fifth embodiment of a method of processing sensor data of the present invention. The method further includes:

S45, evaluating a raw observation data for each of the sensors based on an uncertainty and innovation of the state estimation.

S46, before using the raw observation data for measurement updates, removing the raw observation data of poorer quality than expected.

In this embodiment, an availability of the raw observation data of each sensor is assessed by the state estimation uncertainty described above and in combination with the innovation, wherein poor quality raw observation data is removed before the raw observation data is used for the metrological updates, so as to protect the filters from accepting the influence of bad values.

### Embodiment 6

Based on the above embodiments, this application also provides a processing device for sensor data, the device including a memory, a processor and a computer program stored on the memory and executable on the processor, wherein the computer program, when executed by the processor, implements steps of the above processing method for sensor data.

It should be noted that the above device embodiments and method embodiments belong to the same idea, and their specific realization process is detailed in the method embodiments, and the technical features in the method embodiments are correspondingly applicable in the device embodiments, which will not be repeated here.

### Embodiment 7

Based on the above embodiments, this application also provides a computer-readable storage medium, storing a processing program for sensor data, wherein the processing program, when executed by a processor, implements steps of the above processing method for sensor data.

It should be noted that the above medium embodiments and method embodiments belong to the same idea, and their specific realization process is detailed in the method embodiments, and the technical features in the method embodiments are correspondingly applicable in the medium embodiments, which will not be repeated here.

Through the description of the above embodiments, those skilled in the art can clearly understand that the methods of the above embodiments can be implemented by means of software combined with a necessary general-purpose hardware platform, or, of course, by hardware alone, although in many cases the former is the preferred implementation. Based on this understanding, the technical solution of the present disclosure, or the part thereof that contributes to the prior art, can essentially be embodied in the form of a software product. This computer software product is stored in a storage medium (such as ROM/RAM, magnetic disk, or optical disk) and includes several instructions to enable a terminal device (which may be a mobile phone, computer, server, air conditioner, or network device, etc.) to execute the methods of the various embodiments of the present disclosure.

The embodiments of the present disclosure have been described above with reference to the accompanying drawings, but the invention is not limited to the specific embodiments described above, which are merely illustrative and not limiting. One of ordinary skill in the art, inspired by the invention and without departing from the scope protected by the objects and claims of the invention, may also make many forms, all of which fall within the protection of the invention.

### Industrial Applicability

The processing method and device for sensor data, and the computer-readable storage medium of the embodiment of this application, performs preset comparison, shaping, and filtering process on the first sensor data acquired by a plurality of sensors of the aircraft according to categories of the sensors respectively, to obtain the second sensor data; performs alignment process on the second sensor data by means of the preset data buffer and motion states represented by each of the sensors, to obtain the third sensor data; performs data fusion process on the third sensor data in the loose coupling manner, and performs calculation to obtain the current required motion information. Thereby, a multi-sensor data processing and fusion scheme is realized, which enables the aircraft to obtain the motion information with higher accuracy and bandwidth, and better stability and robustness. Therefore, it has industrial applicability.

1. A processing method for sensor data, comprising:
performing preset comparison, shaping, and filtering process on a first sensor data acquired by a plurality of sensors of an aircraft according to categories of the sensors respectively, to obtain a second sensor data;
performing alignment process on the second sensor data by means of a preset data buffer and motion states represented by each of the sensors, to obtain a third sensor data; and
performing data fusion process on the third sensor data in a loose coupling manner, and performing calculation to obtain a current required motion information, wherein an observation model of the data fusion is decoupled into independent measurement equations corresponding to each sensor, and measurement values of each sensor obtained from the measurement equations are sequentially fused during measurement updates.

2. The processing method for sensor data according to claim 1, wherein performing preset comparison, shaping, and filtering process on the first sensor data acquired by a plurality of sensors of the aircraft according to categories of the sensors respectively, to obtain the second sensor data, comprises:
classifying accelerometer data, gyroscope data, magnetic compass data, and barometer data as a first-category sensor data, and classifying navigation positioning data as a second-category sensor data;
collecting the first-category sensor data in an interrupt-driven manner via a preset peripheral bus interface, and collecting the second-category sensor data in a main loop timed polling manner via a preset serial bus interface.

3. The processing method for sensor data according to claim 2, wherein performing preset comparison, shaping, and filtering process on the first sensor data acquired by a plurality of sensors of the aircraft according to categories of the sensors respectively, to obtain the second sensor data, further comprises:
accumulating angular increments of multiple consecutive sampled values within each calculation cycle during performing calculation on the accelerometer data and the gyroscope data, to obtain an accumulation value for the calculation cycle;
replacing a single sample of the accelerometer data and the gyroscope data with the accumulation value as an input to a preset inertial navigation algorithm while performing the calculation.

4. The processing method for sensor data according to claim 2, wherein performing preset comparison, shaping, and filtering process on the first sensor data acquired by a plurality of sensors of the aircraft according to categories of the sensors respectively, to obtain the second sensor data, further comprises:
comparing a first accuracy state of a primary navigation positioning module and a second accuracy state of a backup navigation positioning module, and switching the backup navigation positioning module to the primary navigation positioning module when the first accuracy state is inferior to the second accuracy state;
removing data frames belonging to bad values in the navigation positioning data according to a number of stars and an accuracy factor contained in the accuracy state.

5. The processing method for sensor data according to claim 2, wherein performing preset comparison, shaping, and filtering process on the first sensor data acquired by a plurality of sensors of the aircraft according to categories of the sensors respectively, to obtain the second sensor data, further comprises:
monitoring a first barometer sampling data of a primary barometer module and a second barometer sampling data of a backup barometer module in real time;
switching the backup barometer module to the primary barometer module when there is no measurement value for the first barometer sampling data within a first preset period or there is no change in the measurement value for the first barometer sampling data within a second preset period.

6. The processing method for sensor data according to claim 2, wherein performing preset comparison, shaping, and filtering process on the first sensor data acquired by a plurality of sensors of the aircraft according to categories of the sensors respectively, to obtain the second sensor data, further comprises:
monitoring a first module data of a primary magnetometer module and a second module data of a backup magnetometer module in real time;
switching the backup magnetometer module to the primary magnetometer module when the first module data is inferior to the second module data, or the first module data is empty within a third preset period.

7. The processing method for sensor data according to claim 1, wherein performing alignment process on the second sensor data by means of the preset data buffer and motion states represented by each of the sensors, to obtain the third sensor data, comprises:
setting buffers of length corresponding to each of the sensors according to an update rate of each sensor, and saving historical data frames of each sensor for a preset period through each buffer, wherein a hysteresis-corrected timestamp is carried in each of the historical data frames; comparing the timestamps during a measurement update phase of applying a preset filtering algorithm, to align the historical data frame with a slow update rate to the motion states represented by the historical data frame with a fast update rate.

8. The processing method for sensor data according to claim 1, wherein performing data fusion process on the third sensor data in the loose coupling manner, and performing calculation to obtain the current required motion information, wherein the observation model of the data fusion is decoupled into independent measurement equations corresponding to each sensor, and measurement values of each sensor obtained from the measurement equations are sequentially fused during measurement updates, comprises:
within a preset range of positioning accuracy, setting an expanded observation noise of each sensor as a noise parameter for extended Kalman filtering;
using an inertial guidance calculation of the third sensor data as a state prediction for the extended Kalman filtering, wherein establishing the observation models of the magnetometer module, the barometer module, and the navigation positioning module respectively, and involving the measurement values of each observation model in the measurement updates of the extended Kalman filtering.

9. The processing method for sensor data according to claim 8, wherein the method further comprises:
calculating a confidence level for a state estimation based on a state error covariance matrix of the extended Kalman filtering;
determining the filtering algorithm is less healthy than expected when the confidence level exceeds a preset threshold, and using another backup filter operating independently for the state estimation.

10. The processing method for sensor data according to claim 9, wherein the method further comprises:
forcing the extended Kalman filtering into a preset auxiliary mode without navigation and positioning when the confidence level of the state estimation of the navigation positioning module exceeds the preset threshold within a preset period;
retaining the calculation for an inertial measurement unit, the magnetometer module, and the barometer module in the auxiliary mode, and performing a preset no-position observation operation.

11. The processing method for sensor data according to claim 9, wherein the method further comprises:
evaluating a raw observation data for each of the sensors based on an uncertainty and innovation of the state estimation;
before using the raw observation data for measurement updates, removing the raw observation data of poorer quality than expected.

12. A processing device for sensor data, comprising a memory, a processor and a computer program stored on the memory and executable on the processor, wherein the computer program, when executed by the processor, implements steps of the processing method for sensor data according to claim 1.

13. A computer-readable storage medium, storing a processing program for sensor data, wherein the processing program, when executed by a processor, implements steps of the processing method for sensor data according to claim 1.

14. A computer-readable storage medium, storing a processing program for sensor data, wherein the processing program, when executed by a processor, implements steps of the processing method for sensor data according to claim 2.

15. A computer-readable storage medium, storing a processing program for sensor data, wherein the processing program, when executed by a processor, implements steps of the processing method for sensor data according to claim 7.

16. A computer-readable storage medium, storing a processing program for sensor data, wherein the processing program, when executed by a processor, implements steps of the processing method for sensor data according to claim 8.

17. A computer-readable storage medium, storing a processing program for sensor data, wherein the processing program, when executed by a processor, implements steps of the processing method for sensor data according to claim 9.
